(19) United States
(12) Patent Application Publication
(10) Pub. No.: US 2026/0318440 A1
(43) Pub. Date: Oct. 15, 2026

(54) INTERNALLY-ACTUATED FLOW CONTROL VALVE

(71) Applicant: Alpha Fluid Dynamics LLC, Dayton, OH (US)

(72) Inventor: Benjamin Cowan Stone, Dayton, OH (US)

(21) Appl. No.: 19/642,040

(22) Filed: Apr. 8, 2026

Related U.S. Application Data
(60) Provisional application No. 63/786,581, filed on Apr. 10, 2025.

(51) Int. Cl. F16K 31/50; F16K 1/12; F16K 31/04

(52) U.S. Cl. CPC F16K 31/508; F16K 1/12; F16K 31/042; F16K 31/047

(57) ABSTRACT

An internally-actuated fluid control valve and a method of controlling a fluid in a fluid handling system. The internally-actuated fluid control valve that has internal actuation in order to provide a valve that performs precise fluid flow control while maintaining an unobtrusive footprint. An internal cavity is constructed with an annular fluid path that extends through the valve. In this way, an actuator assembly is placed entirely within the internal cavity instead of on the outside of the valve. The construction of the actuator assembly allows a complete range of fluid-controlling operation while also having a flow profile that promotes substantially fully ported operation while introducing minimal disruptions to the flow at both high and low flow rates.

This application claims the benefit of U.S. provisional patent application Ser. No. 63/786,581 that was filed on Apr. 10, 2025, by Benjamin Cowan Stone, and having the title INTERNALLY-ACTUATED FLOW CONTROL VALVE, which is incorporated herein by reference in its entirety.

The device and method according to the present disclosure relates generally to a valve used to control the flow of a fluid therethrough, and more particularly to a valve that includes an actuator that is situated substantially within a fluid flow path defined within the valve in a way to introduce minimal disturbances and pressure loss into the flow of fluid.

### BACKGROUND

Industrial piping applications, such as those associated with chemical processing, oil and gas production, fuel delivery, other fluid delivery, pharmaceuticals, power generation, semiconductor manufacturing, food and beverage production, water treatment, research laboratories or the like often require precise control over liquid, gas or flow to ensure process quality, safety or efficiency, particularly for fluids that are prone to cavitation or shear-induced degradation. Piping systems and associated equipment traditionally employ externally-actuated valves (such as globe valves, full-port ball valves, v-port ball valves, butterfly valves or the like) to control the transport fluids within a fluid handling system. Regardless of the method of actuation, the presence of a non-streamlined closure element within valves such as these tends to introduce various undesirable flowpath attributes such as losses in pressure, fluid flow continuity, cavitation, unintended mixing or the like.

In addition to introducing undesirable flow disruptions, the use of externally-actuated actuation of valves within a fluid handling system necessitates increased overall system complexity, such as increased installed space and weight. Moreover, in configurations where the control of flow through the valve is automated, the means of actuation become more complex, which adds to overall system cost and complexity.

Alternative valve designs incorporate internal actuators. In one conventional form, such valves employ coaxial tubes that translate relative to one another. In another conventional form, such valves employ a coaxial translating piston, or in some instances, dual pistons. In both instances, the flow of fluid through the valve encounters disruptive impediments, such as those encountered with butterfly, globe or v-port ball valves. Moreover, the flow typically passes through holes, slots or meshes that introduce a torturous flow path that in turn leads to pressure loss, induced shear and other unfavorable conditions.

### SUMMARY

According to one aspect of the present disclosure, an internally-actuated fluid control valve includes a valve assembly and an actuator assembly. The valve assembly includes an inlet bell, a capsule, a center frame, an outlet bell and a nacelle. Together, these components define an internal cavity with an annular fluid path that extends axially through the valve. The actuator assembly is disposed entirely within the internal cavity and secured to the center frame. The actuator assembly includes a source of motive power and a lead screw assembly responsive to the source of motive power to translate the capsule relative to the center frame along a portion of the annular fluid path that is fluidly upstream of the center frame.

According to another aspect of the disclosure, a method of controlling a fluid in a fluid handling system is disclosed. The method includes configuring a valve assembly to have an actuator assembly disposed entirely within a fluid flow and secured to at least a portion of the valve assembly such that upon introduction of the fluid into the valve assembly, the actuator assembly is operated to adjust the fluid flow through the valve assembly. The actuator assembly includes a source of motive power and a lead screw assembly responsive to the source of motive power to translate a portion of the actuator assembly relative to the valve assembly along a fluidly upstream portion of a fluid path.

### BRIEF DESCRIPTION OF THE SEVERAL VIEWS OF THE DRAWINGS

The following detailed description can be best understood when read in conjunction with the following drawings, where like structure is indicated with like reference numerals and in which:

FIG. 1A depicts a side elevation cutaway of an internally-actuated fluid control valve in an open position according to an aspect of the present disclosure;

FIG. 1B depicts a side elevation view of the internally-actuated fluid control valve of FIG. 1A that includes a thrust bearing assembly;

FIG. 1C depicts a detail view of an actuator assembly of the internally-actuated fluid control valve of FIG. 1B;

FIG. 2A depicts the internally-actuated fluid control valve of FIG. 1A in a closed position;

FIG. 2B depicts a detail view showing how a surface of the movable capsule contacts an inner surface of the inlet bell when the valve is in the closed position of FIG. 2A;

FIG. 3 depicts in partial isolation how the vanes of the guide vane array may be adjustably pivoted about their radial dimension of the internally-actuated fluid control valve of FIG. 1A;

FIG. 4 depicts details of an information processing device that either signally cooperates with or is formed as a part of the internally-actuated fluid control valve to provide control therefor;

FIG. 5 depicts details of an optional converging-diverging exit nozzle that is formed in an axially downstream portion of the internally-actuated fluid control valve of FIG. 1A;

FIG. 6 depicts a version of the internally-actuated fluid control valve with an additional internal conduit to allow the introduction of a secondary fluid of the internally-actuated fluid control valve of FIG. 1A;

FIG. 7 depicts an embodiment of the internally-actuated fluid control valve that provides backside impingement cooling of a seal assembly for use in high-temperature applications of the internally-actuated fluid control valve of FIG. 1A; and

FIG. 8 depicts a partial view of an embodiment of the internally-actuated fluid control valve of FIG. 1A with an actuator for use in low-pressure or small diameter applications.

### DETAILED DESCRIPTION

The author of the present disclosure has discovered that one technological difficulty to overcome relates to a fluid control valve that can ensure predictable, controllable flow rates during low flow rate conditions also ensuring little or no pressure drop during high flow rate conditions. The author of the present disclosure has further discovered that another technological difficulty to overcome relates to the use of external actuation of a fluid control valve and the adverse impact that such actuation has on overall valve weight, volume and center-of-gravity. The author of the present disclosure has discovered that yet another technological difficulty to overcome relates to avoiding poor flow characteristics such as cavitation, eddy current formation or undue turbulence for fluid control valves that have abrupt changes in flow directions or geometries, as well as how to change a setting on such valves without either the aforementioned actuator arrangement or providing a pressurized secondary fluid. The present technical solution as provided by this disclosure is to provide a fluid control valve that has internal actuation in order to provide a valve that performs precise fluid flow control while maintaining a minimally obtrusive footprint.

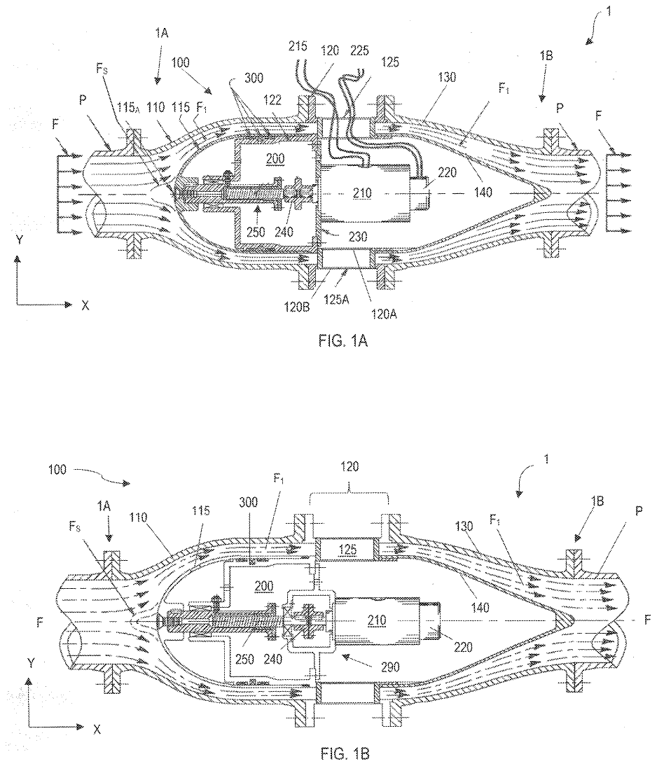

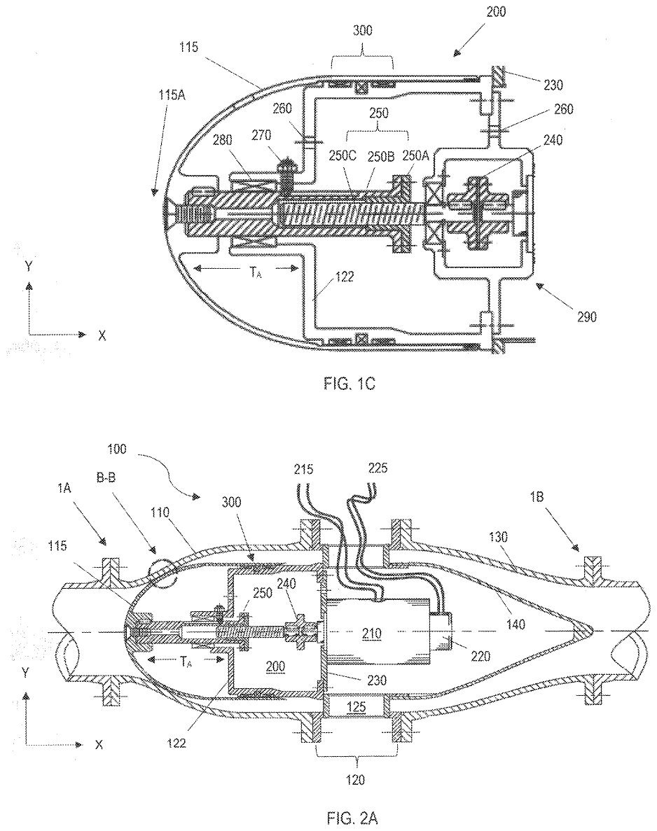

Referring initially to FIGS. 1A and 1B, an internally-actuated fluid control valve 1 is shown in an open position such that a fluid F may be permitted to flow. By such design, the internally-actuated fluid control valve 1 may be substantially fully ported in that when fully open, the presence of an actuator introduces little or no obstructions to the flowpath and as a consequence causes no more than a negligible pressure drop into the flow. In one form, when the internally-actuated fluid control valve 1 is fully open, the pressure drop introduced into the flow is little or no more than that introduced by the same length of flowpath without such actuator. In one form, the internally-actuated fluid control valve 1 may be used in conjunction with piping P or other parts of a fluid-handling system (not shown), such as being secured at both its upstream and downstream ends as shown. The internally-actuated fluid control valve 1 includes a valve assembly 100 and an actuator assembly 200 that together selectively permit or inhibit the flow of the fluid F as it enters a valve proximal end 1A and travels along a substantially annular fluid path F₁ until it is discharged at a valve distal end 1B. As can be seen, the exterior (or external) dimension profile of the internally-actuated fluid control valve 1 is such that—when situated within a material handling system or related ambient environment—the projection of the internally-actuated fluid control valve 1 into such environment is substantially no more than that defined by the adjacent piping P to which the internally-actuated fluid control valve 1 is fluidly coupled. In this way, the internally-actuated fluid control valve 1 may be placed into a tight space in a fluid handling system that it otherwise might not have were any actuation means implemented on a valve exterior surface.

The valve assembly 100 further includes an inlet bell (or housing) 110, a center frame 120 and an outlet bell (or housing) 130 that together define the substantial axial entirety along the X-axis and outer structural attributes. In one form as shown, the inlet bell 110, center frame 120 and outlet bell 130 may be joined to one another through conventional means, such as bolted flanges, welding, adhesives, threaded attachment, pipe couplings or combinations thereof. In addition, these components may be made from known structural materials that are suitable for the end-use application of the internally-actuated fluid control valve 1, including low-temperature metals, high-temperature metals, low-temperature plastics, high-temperature plastics, composites or the like. In one form, the inlet bell 110, center frame 120 and outlet bell 130 may form a fluid-tight outer shell, such as when they are joined solely by their mutually-facing flanged sections. It will be appreciated that when configured as a fluid-tight containment, these components, in addition to being fit within tight tolerances, may also include suitable seals, gaskets or other leakage-reducing components. In addition to forming a substantially fluid-tight portion of the annular fluid path F₁, the center frame 120 also provides a rigid means of support for the actuator assembly 200 as well as for a seal assembly 300 and nacelle 140 both of which will be discussed in more detail as follows. In one form, the structural enclosure that makes up one or more of the inlet bell 110, center frame 120 and outlet bell 130 may be formed as a split case from two-piece assemblies to allow (for example) the upper half may be removed from the lower half. In such case, bolts, interference fits, screwed or slotted attachments or the like may be included to increase access to—and serviceability of—the components contained therein.

In one form of fluid handling, the fluid F enters the internally-actuated fluid control valve 1 through the inlet bell 110. In one form, the inlet bell 110 defines an outer portion of the annular fluid path F₁ for at least a portion of the overall axial length of the internally-actuated fluid control valve 1. An axially translatable capsule 115 is disposed inside the inlet bell 110 and in one form defines an inner portion of an inlet flow cavity portion of the annular fluid path F₁ for at least a substantial majority of the axial length of the inlet bell 110. In this way, the inlet bell 110 and the capsule 115 cooperate to form the substantial entirety of the annular fluid path F₁ at least until the location where the inlet bell 110 and the capsule 115 encounter the center frame 120.

The center frame 120 has a guide vane array 125 that extends between an inner frame hub 120A and an outer frame hub 120B. The guide vane array 125 is made up of some number of circumferentially-spaced, stationary vanes 125A that radially-extend between the inner frame hub 120A and the outer frame hub 120B in order to provide structure for the internally-actuated fluid control valve 1 while also being shaped to provide minimally-disruptive flow profiles. In one form, such shape may be similar to that of airfoil-shaped vanes in an axial-flow gas turbine engine. In such configuration, the vanes form fairings that have fluid dynamic properties such that the shape is configured to minimize pressure drops, discontinuities, turbulence, cavitation or other undesirable properties in fluid F.

As can be seen, a relatively blunt spherical proximal end of the capsule 115 defines a fluid stagnation point 115A that may serve as a mounting or securing location between the capsule 115 and a portion of the actuator assembly 200 as will be discussed in more detail later. The fluid stagnation point 115A may—depending on certain flow characteristics such as the Reynolds Number or the like—correspond to the location where a flow stagnation field Fₛ is likely to form upstream (in one form, roughly 1.5 to 2 pipe diameters) from the fluid stagnation point 115A that arises from the impingement of the flow of fluid F on capsule 115. In this way, the fluid F is uniformly directed into an inlet annular cavity that forms the beginning of the annular fluid path F₁ that is bounded by the wetted surfaces of inlet bell 110 and capsule 115 that in the form shown results in the annular cross-sectional area as being equal to both the inlet and outlet piping P. As will be discussed in more detail as follows, any valve design difficulties that may arise out of the placement and actuation of the capsule 115 in an upstream portion of the internally-actuated fluid control valve 1 and the full (total) pressure of the impinging flow of fluid F are more than overcome by avoiding a different design that involves downstream placement and actuation.

The annular fluid path F₁ continues past the center frame 120 and until the fluid F exits the internally-actuated fluid control valve 1 through the outlet bell 130. In one form, the outlet bell 130 defines an outer portion of the annular fluid path F₁ in a manner that is relatively similar to, but more streamlined than, the inlet bell 110, while the nacelle 140 defines an inner portion of the annular fluid path F₁ in a manner that is relatively similar to, but more streamlined than, the capsule 115. Regardless of differences in how streamlined the capsule 115 and the nacelle 140 are to one another, it will be appreciated that in both instances the shapes are such to keep discontinuity-related turbulence to a minimum while still fitting within the overall dimensions of the internally-actuated fluid control valve 1. Unlike the converging portion of the annular fluid path F₁ that the fluid F takes upon entering the internally-actuated fluid control valve 1, the diverging portion of the annular fluid path F₁ that the fluid F experiences upon leaving the internally-actuated fluid control valve 1 acts like a diffusing annular cavity that—with appropriate shaping—is formed with generally stable (rather than generally unstable) diffuser angles until the fluid F is discharged out of the internally-actuated fluid control valve 1 to the next sequential part of the piping P or other parts of a fluid-handling system. Notably, the nacelle 140 (as well as other parts of the annular fluid path F₁) is substantially devoid of a mesh, orifices, ports, slots or related openings or perforations that otherwise could cause fluid disturbances, unrecoverable pressure losses and associated throughput reductions of fluid F.

Referring with particularity to FIG. 1A, the actuator assembly 200 includes a source of motive power shown in the form of motor 210 that delivers relatively high torque rotary movement to a connected shaft (not shown). In one form, motor 210 is a servo motor that in one form receives electric power through power lines 215. In one form, the motor 210 is encased in an isolating containment in order to resist reactive gases or liquids that may be present within the internally-actuated fluid control valve 1, including fluid F. In alternate forms (not shown), the motor 210 may be powered by other means, such as by pneumatic or hydraulic sources; in such configuration, the power lines 215 would instead be pressurized fluid lines. An encoder 220 that is mounted to a distal end of the motor 210 tracks the rotational position or speed of the shaft and conveys such position or speed through position feedback lines 225 to a valve controller, a motor controller, computer or other suitably-configured device (also referred to herein either singularly or collectively simply as “controller”, not shown). In another form (not shown), feedback may be provided to the controller through radio frequency (RF) wireless means such as those associated with nearfield, radio frequency identification (RFID), optical or other means. In still another form (not shown), the motor 210 may be powered by internal batteries. The encoder 220 may be an absolute encoder, an incremental encoder, a linear encoder, an optical encoder or the like. A motor mounting plate 230 provides a frame-like structural member with which to secure or otherwise attach the motor 210 to the center frame 120. A shaft coupling 240 acts to transmit rotational movement of the motor 210 to a lead screw assembly 250 that, along with the shaft coupling 240, will be described in more detail as follows. In the present embodiment, the shaft coupling 240 is substantially open to a volumetric space defined within an axially forward-extending portion 122 of the center frame 120. As will be described next, it may instead be encased within a thrust bearing assembly 290.

Referring with particularity to FIG. 1B, an internally-actuated fluid control valve 1 is shown with the thrust bearing assembly 290 that surrounds the shaft coupling 240. It will be appreciated that the embodiments depicted in any or all of the present figures may or may not include the thrust bearing assembly 290 as part of (or a replacement for) the motor mounting plate 230, depending on the aforementioned magnitude of axial loads imposed on one or more of the motor 210 and shaft coupling 240 by the fluid flow F.

Referring next to FIG. 1C, it will be appreciated that while the upstream surface of the capsule 115 is subjected to some measure of static and dynamic pressure forces exerted by the incoming fluid F, and that these forces are reacted by means of the lead screw assembly 250, the shaft coupling 240 and the motor 210 of FIG. 1B and are transmitted to the center frame 220 by means of the motor mounting plate 230. In applications where the magnitude of such static and dynamic pressure forces exceed the thrust load capacities of the shaft coupling 240 or motor 210, the motor mounting plate 230 may be reconfigured to house the aforementioned thrust bearing assembly 290 which isolates the shaft coupling 240 and motor 210 from the load path.

Regardless of which of the embodiments of FIG. 1A or 1B are employed, one or more vent holes 260 may be formed in the center frame 120 as well as other components including (for the embodiment of FIG. 1B), the thrust bearing assembly 290, in any event to ensure that all of the internal volumes of the internally-actuated fluid control valve 1 remain at ambient pressure irrespective of the translation of capsule 115, which would otherwise place adverse pressure differentials on the seal assembly 300 that will be discussed in more detail as follows. In operation, the motor 210, power lines 215, encoder 220, position feedback lines 225 cooperate with the controller to form a closed-loop position control servo system.

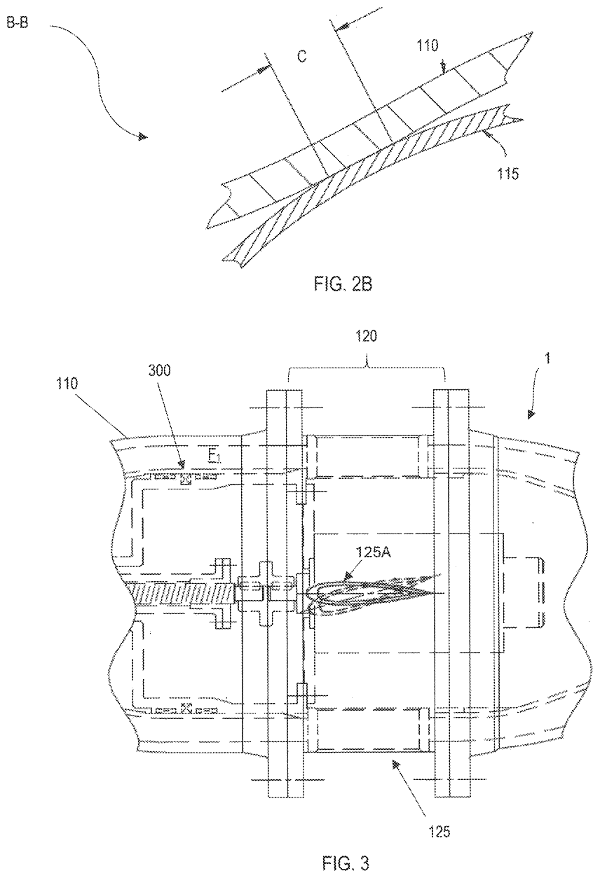

The lead screw assembly 250 includes a lead screw nut 250A, a lead screw sleeve 250B and a lead screw 250C. In one form, the lead screw 250C is threaded lead screw nut 250A which is rigidly fixed to lead screw sleeve 250B that is in turn rigidly keyed to the capsule 115. In this way, any rotation of the motor 210 imparts linear translational movement to the capsule 115, such movement is guided by a linear bearing 280 that is mounted on an inner wall of the center frame 120. In one form where the valve assembly 100 defines a generally axisymmetric shape about the axis that coincides with the annular fluid path F₁, the outer wall of the center frame 120 has a cylindrical profile such that its radially outward-facing surface forms a close fit between it and an inner wall of the capsule 115 such that together they provide a mounting location for the seal assembly 300. In one form, the capsule 115 and the axially forward-extending portion 122 of the center frame 120 define a nested and substantially fluid-tight cooperation between them regardless of whether the internally-actuated fluid control valve 1 is shown in its open (FIG. 1A) or closed (FIG. 2A, as will be discussed in more detail as follows) position. As can be seen, the axial overlap created by this nested joining extends over an entirety of an axial travel path T_{A} that coincides with the distance along the X-axis that the capsule 115 moves relative to the axially forward-extending portion 122 of the center frame 120 when shuttling back and forth between the open position of FIG. 1A and the closed position of FIG. 2A. In one form, the inlet bell 110, outlet bell 130 and a linear bearing frame that forms part of the axially forward-extending portion 122 of the center frame 120 may be implemented each as halves that may be assembled and disassembled along a common join location to facilitate maintenance, such as is common to jet engine cases or covers.

Together, the lead screw assembly 250 responds to rotational movement imparted to it from the motor 210 and shaft coupling 240 such that upon being rotated, the lead screw 250C forces the capsule 115 to translate either forward or rearward along the axial dimension of the internally-actuated fluid control valve 1 that as shown coincides with the X-axis. Upon axial translation of the capsule 115, a variable restriction is formed in the annular fluid path F₁ that in turn creates a controlled variable-area annulus which modulates the amount of the fluid F that passes from the proximal to the distal end of the internally-actuated fluid control valve 1. A set screw 270 is threaded through a wall of the center frame 120 and engages in a slot that is formed in the lead screw sleeve 250B is used to inhibit any rotation of the translating capsule 115 that otherwise may arise out of frictional coupling between the lead screw 250C and the lead screw nut 250A. Although not shown, it will be appreciated that other actuation types may be employed rather than the lead screw assembly 250. For example, hydraulic cylinder, air cylinder, internal mechanical linkage, piezoelectric or related actuation configurations may be employed (depending on factors such as application size requirements, piping system pressure or the like). It will be further appreciated that all such forms are deemed to be within the scope of the present disclosure.

Significantly, FIGS. 1A through 1C (as well as FIG. 2A) show how the actuation that is depicted herein does not take place in a downstream portion of the annular fluid path F₁ where adverse (that is to say, positive) pressure gradients that arise out of the diverging nature of the downstream portion of the annular fluid path F₁ and the inherent increase in static pressure can lead to flow momentum that is inadequate to overcome streamwise pressure and viscous drag of the fluid. This inadequacy can result in unpredictable and unstable boundary layer flow separation from the surface of downstream components (such as those similar to nacelle 140) which results in the formation of a local flow separation from the surface resulting in vortex-based backflow close to the surface and which generates noise, vibration (such as in components similar to piping P) and potential flow cavitation. Instead, flow regulation is achieved by the interaction of the static pressure distribution upstream of the translating capsule 115 and the annular fluid path F₁ that forms between it and the inlet bell 110. In other words, flow regulation is achieved by the taking advantage of well-controlled (or well-behaved) upstream flow of the fluid F near the stagnation point 115A and resulting flow stagnation field Fₛ along with its related, upstream static pressure distribution that is inherent in the impingement of the flow of fluid F on the capsule 115. This interaction of two streamlined flow upstream surfaces avoids having to design complex flow geometries through which a gross pressure from a fluid is being forced to pass, especially in the presence of the aforementioned mesh, orifices, ports, slots or related openings or perforations where eddy flows (such as localized backflow), flow separation, unrecoverable pressure losses and unexpected irregularities may be present, particularly for valves are at their nearly-closed position. In particular, unlike downstream actuation configurations where diffuser angles and geometric cross-sections must be carefully selected to avoid flow instabilities that arise out of unfavorable pressure differential distributions, the upstream actuation disclosed herein allows for relatively straightforward converging cone shape choices in order to concentrate the annular fluid path F₁ in that the incoming flow of fluid F is working against a favorable pressure differential distribution. The present upstream closure means that fluid pressure forces play the principal role in determining the flow pattern of the fluid F, and do so in a very smooth, generally ideal fashion. Contrarily, in a downstream closure, fluid viscous forces play the principal role, and they do so in a very disruptive, unpredictable fashion that can lead to flow disturbances that are difficult or impossible to overcome.

One or more seal assemblies 300 may be formed between various adjacent surfaces that move either axially or circumferentially relative to one another. For example, one seal assembly 300 may be placed between facing surfaces of the capsule 115 and the axially forward-extending portion 122 of the center frame 120 such that when situated between an outer surface of the latter and an inner surface of the former, the capsule 115 may axially slide in a fore or aft direction in response to movement imparted to it through the axially forward-extending portion 122 of the center frame 120, all while reducing or substantially eliminating fluid or thermal leakage. Depending on the use environment (such as chemical, extreme temperatures, food-grade fluids or the like), the seal assemblies 300 may be formed from suitable materials such as silicones, abradable metals, polymers or the like all of which are within the scope of the present disclosure. It will be appreciated that the placement, size, shape and material choice of such seal assembly 300 as shown is notional, and that other choices may be adopted to comport with a particular end-use. Relatedly, when the internally-actuated fluid control valve 1 is used for various specific applications or environments, such as those featuring elevated temperatures, caustic fluid flows, slurry or high-particulate fluid flows or the like), the seal assembly 300 should be configured accordingly. It will be appreciated that all such variations of the seal assembly 300, as well as that of various other components, are within the scope of the present disclosure.

In one form, one or more blow-in doors (also referred to as suck-in doors or peripheral ejectors) may be placed in a fluidly upstream portion of the internally-actuated fluid control valve 1. In one form (not shown), such doors may be placed in one or more circumferential parts of the inlet bell 110 such that when open, they can transfer at least a portion of the incoming flow of fluid F out of the upstream portion of the annular fluid path F₁ for reintroduction elsewhere (such as into a downstream portion of the annular fluid path F₁ that corresponds to the outlet bell 130. By way of example, the peripheral ejectors function to allow static ambient air to be induced into the flow of the fluid F in general and (in one form) the annular fluid path F₁ in particular. In this way, flow regulation is achieved by the taking advantage of well-controlled (or well-behaved) upstream pressure differences that can act as the driving force with which to then accelerate the entrained portion of the fluid F and have it exit through the outlet bell 130.

Referring next to FIGS. 2A and 2B, the internally-actuated fluid control valve 1 is shown in a closed position after having been actuated along the capsule axial travel path T_{A} by the actuator assembly 200. In its forwardmost position as shown, the capsule 115 contacts an inner wall of the inlet bell 110 (shown in section B-B of FIG. 2A and in detail in FIG. 2B), forming a fluid-tight valve seat that in turn prohibits any further flow of fluid F. Contact C between the inlet bell 110 and the capsule 115 that forms a fluid-tight valve seat at the point of contact C that in turn prohibits any further flow of fluid F while the internally-actuated fluid control valve 1 is in the closed position. In one form, the portion of the valve seat that is defined by the contact C may be a linear segment or a curved segment, or longer or shorter, depending on the acceptable leakage rate of the internally-actuated fluid control valve 1 when closed.

Referring next to FIG. 3, a partial isolation view shows how in an optional form the vanes 125A (presently shown as fairings) of the guide vane array 125 may be adjusted, thereby forming a variable-vane portion within the annular fluid path F₁. As shown, the fairings define the aforementioned fluid dynamic profile along the annular fluid path F₁. By being made to selectively pivot about their radial (that is to say, height-wise) axis, the vanes 125A may be made more particularly responsive to a given fluid F based on present conditions such as those associated with rate of flow, temperature, viscosity or the like. The angle of attack of the vanes within the guide vane array 125 may be adjusted to either eliminate undesired swirl components of an incoming flow (that is, to recover flow static pressure and promote outlet flow uniformity), or alternatively, to induce desired swirl into the outlet flow to promote mixing of multicomponent flows.

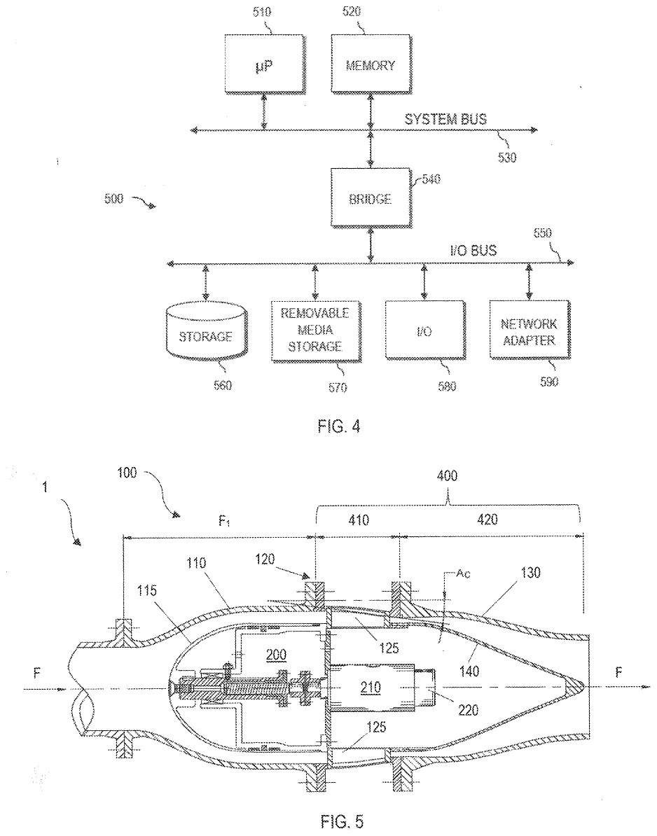

Referring next to FIG. 4 in conjunction with FIGS. 1A through 3 and 5 through 8, a block diagram showing an information processing device 500 that in one form may be used to provide computer control of at least a portion of the internally-actuated fluid control valve 1, such as for implementing the various processes described herein. The exemplary information processing device 500 includes one or more (hardware) processors (also referred to herein as microprocessors 510 (or in the alternative, a system-on-chip (SoC) microcontroller that itself forms an integrated circuit that also includes memory and one or more peripherals) for executing instructions that make up a computer program and corresponding (hardware) memory 520 that are connected to a system bus 530. Information can be passed between the system bus 530 (via a suitable bridge 540) and a local bus 550 that is used to communicate with various input/output devices. For instance, the local bus 550 is used to interface peripherals with the one or more microprocessors 510, such as storage 560 (for example, hard disk drives); removable media storage devices 570 (for example, flash drives, DVD-ROM drives, CD-ROM drives, floppy drives or the like); I/O devices 580 such as input device (for example, mouse, keyboard, scanner or the like) output devices (for example, monitor, printer or the like); and a network adapter 590. The present list of peripherals is mentioned by way of illustration and is not intended to be limiting. Other peripheral devices may be suitably integrated into the information processing device 500. In a similar manner, all such devices and variants thereof are within the scope of the present disclosure. In another form, the I/O devices 580 may include various display screens, such as those available on a computer, laptop, mobile telephone, smart watch, graphical user interface (GUI) or other related data-reporting device, including those placed upon or otherwise readily accessible to the individual being monitored. Such display screens cooperate with the information processing device 500 such that a program stored in memory 520 and executed by the one or more microprocessors 510 can convey to a user an indication on the I/O device 580 of any desired information) relating to the internally-actuated fluid control valve 1.

The one or more microprocessors 510 control operation of the exemplary information processing device 500. Moreover, one or more of the microprocessors 510 execute computer-readable code (for example, stored in the memory 520, storage 560, removable media insertable into the removable media storage 570 or combinations thereof, collectively or individually referred to as computer-program products) that instructs the one or more microprocessors 510 to implement the computer-implemented processes herein that may be in the form of a machine-executable process executed on the information processing device 500, or on any other structure described more fully herein.

Thus, the information processing device 500 or components thereof can implement processes (included computer-implemented processes) that are stored on the memory 520 as well as one or more computer-readable storage devices 560, 570 as set out in greater detail herein. Computer-program code (also referred to herein as machine code) for carrying out operations for aspects of the present disclosure may be written in any combination of one or more programming languages. This code may execute entirely or partially on the information processing device 500 the latter in cases where distributed computing or related analysis is being utilized. In the latter scenario, the remote computer may be connected to the information processing device 500 through any type of network connection, for example, using the network adapter 590 of the information processing device 500. The computer-readable program instructions and related code described herein can be downloaded to the information processing device 500 from the one or more computer-readable storage media (such as the memory 520 or one or more computer-readable storage devices 560, 570) or to an external computer or external storage device through a network such as the Internet, a local area network (LAN), a wide area network (WAN) either of which through wired or wireless means. In one form, electronic circuitry including, for example, programmable logic circuitry, field-programmable gate arrays (FPGA), application-specific integrated circuits (ASICs) or programmable logic arrays (PLA) may execute the computer-readable program instructions through the utilization of state information of the computer-readable program instructions in order to personalize the electronic circuitry.

In implementing computer aspects of the present disclosure, any combination of computer-readable medium may be utilized. The computer-readable medium may be a signal medium (that is to say, transitory propagating signal per se, whether as baseband or as part of a carrier wave, in either event as one that does not encompass a computer-readable storage medium), a computer-readable storage medium, or a combination thereof. Moreover, a computer-readable storage medium may be implemented in practice as one or more distinct mediums. Unlike transitory signals, such computer-readable storage medium (such as memory 520 or the computer-readable storage devices 560, 570) is a tangible device or related piece of hardware that can retain and store a program (instructions) for use by or in connection with an instruction execution system, apparatus or device, for example, a computer or other processing device such as the information processing device 500 which is set out more fully herein. Specific examples (a non-exhaustive list) of the computer-readable storage medium include the following: a hard disk, a random-access memory (RAM), a read-only memory (ROM), an erasable programmable read-only memory (EPROM), flash memory, a portable computer storage device, an optical storage device such as a compact disc read-only memory (CD-ROM) or digital video disk (DVD), or any suitable combination of the foregoing. In particular, a computer-readable storage medium includes computer-readable hardware such as a computer-readable storage device, for example, the aforementioned memory 520. As such, a computer-readable storage device and computer-readable hardware are physical, tangible implementations that are non-transitory in that the content will persist until acted upon, for example, by removing power, by overwriting, deleting, modifying or the like. Moreover, since hardware comprises one or more physical elements or components of a corresponding computer system (such as information processing device 500), hardware does not encompass software per se.

It will be appreciated that the information processing device 500 may be configured into numerous form factors all of which are within the scope of the present disclosure. For example, in one form, the information processing device 500 may be configured as part of the internally-actuated fluid control valve 1, whether formed within a housing that contains the internally-actuated fluid control valve 1 or as part of a separate wired or wirelessly connected control mechanism. In another form, the information processing device 500 may be configured as a stationary on-site or off-site stationary device, while in another form to be miniaturized such that it may take on a wearable form factor, such as being affixed to the individual, such as through wrist-mounted, arm-mounted, torso-mounted, leg or ankle-mounted configurations. It will be appreciated the device being mounted to body parts other than those listed are still within the scope of the present disclosure. In still another form factor, the information processing device 500 may be configured to be in the cloud. Communication within or by the information processing device 500 may be through wired or wireless means where the latter may include known long-range or short-range approaches such as mobile telephony, WiFi, Bluetooth, nearfield communications or the like.

The various components that make up the information processing device 500 may be configured as a controller and include one or more of the various components, including the I/O 580 as a user interface, the one or more microprocessors 510 and memory 520 the last of which may contain program code, machine codes, native instruction sets, computer-readable instructions or related data structures such that upon loading into the memory 520, the program code is particularly configured to execute one or more steps in a manner consistent with the methods disclosed herein. In addition, the controller may include a communications circuit (such as through the network adapter 590 or other communication means) that may be either wired or wireless such in when configured as the latter, it may include a suitable radio-frequency transceiver that can access an external network (not shown). Within the present disclosure, the program code will be understood to include the organized collection of instructions and computer data that make up particular application software and system software the latter of which may include operating system software and basic input/output that relates to the operation of the information processing device 500, regardless of its form factor. This and other software (such as system software or application-specific software) provides programmed instructions that may be implemented on the one or more microprocessors 510 to allow it (or them) to interact with other parts of the information processing device 500 or other computer-based equipment in order to perform one or more of the data acquisition, processing, communicating, analysis and related functions disclosed herein. For example, source code may be converted into executable form as machine code for use by the one or more microprocessors 510; such machine code is predefined (or configured) to perform a specific task in that it is taken from a machine language instruction set known as the native instruction set that may be part of a shared library or related non-volatile memory (including memory 520 and the removable media storage devices 570) that is specific to the implementation of the one or more microprocessors 510 and its (or their) particular Instruction Set Architecture (ISA). As such, software instructions such as those embodied in the corresponding portion of the machine code configure the one or more microprocessors 510 to provide the program structure and associated functionality as discussed herein.

In one form, the controller is configured as a proportional-integral-derivative (PID) controller so that a feedback-based loop may be used to provide automated operation, including when continuous control is desired. For example, the PID controller may be used to regulate the speed, operating temperature, power consumption or other attribute of the motor 210. Likewise, the PID controller may in one form utilize various valve flow setpoint values may in order to calculate positions of the internally-actuated fluid control valve 1 as well as that of some of its components such as the guide vane array 125. In one form, the one or more values may be used as a feedforward term for the intended setpoint. In this capacity, the PID controller is used to generate the compensational term for the new position of the motor 210, vanes 125A or other component of interest. In one form, both open-loop and closed-loop features may be used by the PID controller. For example, a new valve position or setting may be the sum of a feedforward (open-loop) term and the feedback (closed-loop) term, and the PID controller will command the internally-actuated fluid control valve 1 to change to the new setpoint. It will be appreciated by those skilled in the art that the new valve setpoint, even though it may utilize feedback information, may not use target values insofar as they may constitute a control term of interest.

Sensors (not shown) may be disposed in, on or around the internally-actuated fluid control valve 1 in order to monitor various operating parameters of the internally-actuated fluid control valve 1, as well to work in conjunction with the information processing device 500 in the event that process changes are necessary. In one form, the sensors and the information processing device 500 may be used to change the position of one or more of the capsule 115, vanes 125A, motor 210 or other equipment (not shown) within the fluid handling system. The cooperation of such equipment provides the internally-actuated fluid control valve 1 the ability to accurately set flow volumes by means of a closed-loop positioning servo system; such a system (which in one form may form a part of the fluid handling system) is particularly beneficial for attaining precise delivery of the fluid F, such as for chemical mixtures, fuel-to-air combustion ratios or the like.

In one form such as that associated with the embodiment of FIG. 3, the aforementioned valve controller, motor controller, computer or other suitably-configured information processing device may be used as part of the operation of the internally-actuated fluid control valve 1 in order to perform adjustments to the vanes 125A in response to a desired process outcome associated with a fluid handling system. As such, within the present disclosure, it will be understood by one skilled in the art that aspects disclosed herein may be embodied as a system or process. It will be further understood that any operations, functions, logical blocks, modules, circuits and steps or events described may be implemented in hardware, software, firmware or any combination thereof. Moreover, if implemented in software, such operations may be stored on or transmitted over as one or more instructions or code on a computer-readable medium. The steps or events of a method disclosed herein may be embodied in a processor-executable software module, which may reside on a tangible, non-transitory version of such computer-readable medium such that the medium be in any available form that permits access to the events or steps by a processor or related part of a computer. By way of example, and not limitation, such non-transitory computer-readable medium may comprise RAM, ROM, EEPROM, CD-ROM or other optical disk storage, magnetic disk storage or other magnetic storage devices, flash memory or any other form that may be used to store desired program code in the form of instructions or data structures and that may be accessed by a processor or related part of a computer. Combinations of the foregoing should also be included within the scope of non-transitory computer-readable media. Additionally, the operations of a method may reside as one or any combination or set of codes or instructions on a tangible, non-transitory machine readable medium or computer-readable medium, which may be incorporated into a computer program product. Furthermore, in one non-limiting form. upon having the program code means loaded into memory in general (and in one form into ROM in particular), the processor, microprocessor, controller, microcontroller, SoC or related computational device becomes a specific-purpose machine configured to perform the various computational tasks described herein. In this way, the associated computer becomes a particularly-adapted computer or computer-related data processing device that possesses particular capabilities tied to the resulting instruction set architecture.

Referring next to FIG. 5, the outlet bell 130 of the internally-actuated fluid control valve 1 may in one optional form include a converging-diverging (C/D) exit nozzle 400 examples of which are used in conjunction with gas turbine engines in general and aircraft-based propulsion systems in particular. As can be seen, the C/D exit nozzle 400 is formed in an axially downstream portion of the internally-actuated fluid control valve 1 such that it is the last component the fluid F will encounter before being discharged to piping P (not presently shown) or other part of a fluid handling system. It will be appreciated that wetted surface contours the internally-actuated fluid control valve 1 (including those of the guide vane array 125 profile and angle of attack) may be selected to provide various outlet velocity profiles, depending on the need of any downstream equipment or process control needs. Moreover, in a manner similar to the aforementioned seal assembly 300, choices related to placement, size, shape and material choice of wetted surface contours of the internally-actuated fluid control valve 1 are depicted notionally, and that other choices may be adopted to comport with a particular end-use application or environment, and that all such variations are within the scope of the present disclosure. In one form, the guide vane array 125 is configured to define a converging annular region 410 while the space between the outlet bell 130 and the nacelle 140 defines a diverging annular region 420. In certain configurations (not shown), a secondary fluid may be introduced so that the C/D exit nozzle 400 functions as an ejector. In operation, the fluid flow F enters the internally-actuated fluid control valve 1 along the annular fluid path F₁ and then transition in a controlled (that is to say, relatively smooth, turbulence-free) manner to encounter the converging annular region 410 that forms a general angle of convergence A_{C}. On one form, the diverging annular region 420 that is defined by curvature and length of the flow surfaces of the nacelle 140 and the outlet bell 130 may be selected and optimized such that the flow characteristics of the fluid flow F at exit transitions from an annular form back into a circular cross-section. Significantly, this arrangement improves the ability to control the mass flow through the C/D exit nozzle 400 with the aforementioned actuator assembly 200, capsule 115 and ancillary components.

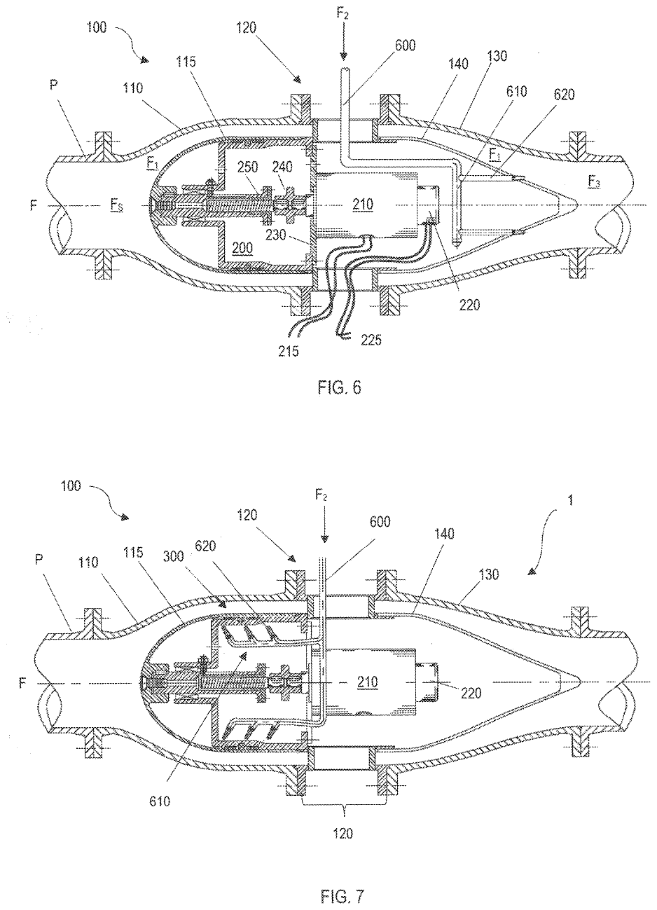

Referring next to FIGS. 6 and 7, the internally-actuated fluid control valve 1 is shown where a secondary flow is introduced (FIG. 6) to provide—in one form—backside impingement cooling (FIG. 7), such as from static, ambient air, to temperature-sensitive components such as a seal assembly 300. In one form, conduit 600 that carries a secondary fluid through a secondary fluid path F₂ is routed through the center frame 120 and routed around the motor 210 to extend rearwardly through a manifold 610 and individual ejectors 620 that extend through the nacelle 140. In this way, applications where the internally-actuated fluid control valve 1 is handling heated and cooled fluids, the associated range of potentially extreme fluid temperatures that may otherwise compromise the functionality and service life of the valve—such as through one or both of thermal expansion and material degradation—may be mitigated through the selective introduction of a cooling (such as the aforementioned ambient air) or heating fluid, respectively. Consequently, the secondary fluid path F₂ may be used in this embodiment, either to cool one or more components of the internally-actuated fluid control valve 1 in high-temperature applications, or to warm them in low temperature applications. In one form, the secondary fluid that is introduced into the secondary fluid path F₂ may be compressed, including from an outside source. Regardless of the form of the secondary fluid, such a configuration is beneficial for nonmetallic valve components such as (in addition to the seal assembly 300), actuator assemblies, elastomeric valve seats and related components where temperature extremes may be deleterious. Thus, while there are natural and synthetic elastomers that may be used for the internally-actuated fluid control valve 1 that can handle temperature extremes (such as polyphenylene sulfide-filled Teflon that can function to −100° F., or graphite-filled or Teflon-filled PEEK that can function up to 500° F., the use of secondary flow may be implemented by the embodiments shown herein to either provide an extended permissible operating temperature range, or increased reliability and service life at a specified operating temperature range. As shown, the annular fluid path F₁ and the secondary fluid path F₂ form a mixed flow F₃ that is the sum of F_{A}+F_{S}.

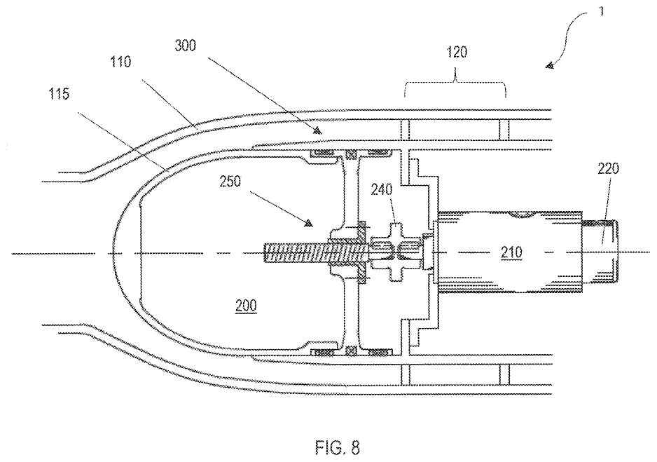

Referring next to FIG. 8, in situations where the piping (not presently shown) has a small diameter, the internally-actuated fluid control valve 1 may permit some of the components to be simplified. For example, both the motor 210 and the seal assembly 300 may be made to be smaller, thinner or otherwise less structurally robust. In one form, the lead screw assembly 250 may be integrated into the seal assembly 300 and capsule 115 rather than into the axially forward-extending portion 122 (not presently shown) of the center frame 120. In one particular form, the valve assembly 100 and actuator assembly 200 may be part of a medical tool (not shown) that may have to fit within tight confines, including those associated with medical devices, such as for circulatory system applications. In such case, the motor 210 may be replaced with or operated by other means for actuating the lead screw assembly 250, such as through the aforementioned pneumatic or hydraulic sources. Within the present context, small diameter piping may exhibit similar attributes to low pressure applications, as well as to applications where valve life is not of key concern, such as with inexpensive, plastic consumer products, throw-away products or the like. Significantly with regards to these applications, the simplified valve geometry disclosed herein takes advantage of low part count and corresponding valve cost.

While a significant part of the present disclosure emphasizes how the internally-actuated fluid control valve 1 may be optimized to minimize flow disturbances and associated pressure drops, (particularly during high flow rate conditions, as well as to reduce the impact of components within the flow stream, such as actuators, guide vanes or the like), the author of the present disclosure recognizes that there may be configurations where the internally-actuated fluid control valve 1 may be turned around, such as to operate backwards relative to the direction of the fluid flow. Moreover, in end-use applications that do not prioritize minimal flow disturbance and pressure loss, the internally-actuated fluid control valve 1 may instead be configured as a bidirectional flow control valve (not shown), in which case the capsule 115 (for example) could actuate towards the downstream direction of the flow. Relatedly, the author of the present disclosure recognizes that there may be configurations where the internally-actuated fluid control valve 1 may need to be shortened, such as for situations the internally-actuated fluid control valve 1 is required to be packaged into an assembly, component or system of limited volume or length; in end-uses such as this, the overall length and diameter of the internally-actuated fluid control valve 1 may be substantially reduced. In each of these other configurations a certain amount of pressure drops, discontinuities, turbulence, cavitation or related undesirable properties in fluid flow can be otherwise tolerated by the configurations shown and described herein.

Within the present disclosure, one or more of the following claims may utilize the term “wherein” as a transitional phrase. For the purposes of defining features discussed in the present disclosure, this term is introduced in the claims as an open-ended transitional phrase that is used to introduce a recitation of a series of characteristics of the structure and should be interpreted in like manner as the more commonly used open-ended preamble term “comprising” and its variants that do not preclude the possibility of additional acts or structures.

Within the present disclosure, terms such as “preferably”, “generally” and “typically” are not utilized to limit the scope of the claims or to imply that certain features are critical, essential, or even important to the disclosed structures or functions. Rather, these terms are merely intended to highlight alternative or additional features that may or may not be utilized in a particular embodiment of the disclosed subject matter. Likewise, it is noted that the terms “substantially” and “approximately” and their variants are utilized to represent the inherent degree of uncertainty that may be attributed to any quantitative comparison, value, measurement or other representation. As such, use of these terms represents the degree by which a quantitative representation may vary from a stated reference without resulting in a change in the basic function of the subject matter at issue.

Within the present disclosure, the use of the prepositional phrase “at least one of” is deemed to be an open-ended expression that has both conjunctive and disjunctive attributes. For example, a claim that states “at least one of A, B and C” (where A, B and C are definite or indefinite articles that are the referents of the prepositional phrase) means A alone, B alone, C alone, A and B together, A and C together, B and C together, or A, B and C together. By way of example within the present disclosure, if a claim recites that data is being acquired from at least one of a first sensor, a second sensor and a third sensor, and if such data is being acquired from the first sensor alone, the second sensor alone, the third sensor alone or any combination of the first, second and third sensors, then such data acquisition satisfies the claim.

Within the present disclosure, the singular forms “a,” “an” and “the” include plural references unless the context clearly dictates otherwise. The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9 to 1.1. Other meanings of “about” may be apparent from the context, such as rounding off, so, for example “about 1” may also mean from 0.5 to 1.4.

For the recitation of numeric ranges herein, each intervening number there between with the same degree of precision is explicitly contemplated. For example, for the range of 6 to 9, the numbers 7 and 8 are contemplated in addition to 6 and 9, and for the range 6.0 to 7.0, the number 6.0, 6.1, 6.2, 6.3, 6.4, 6.5, 6.6, 6.7, 6.8, 6.9 and 7.0 are explicitly contemplated.

Within the present disclosure, the following claims are not intended to be interpreted based on 35 USC 112(f) unless and until such claim limitations expressly use the phrase “means for” or “steps for” followed by a statement of function void of further structure. Moreover, the corresponding structures, materials, acts and equivalents of all means or step plus function elements in the claims that follow are intended to include any structure, material or act for performing the function in combination with other claimed elements as specifically claimed.

The corresponding structures, materials, acts, and equivalents of all means or step plus function elements in the claims that follow are intended to include any structure, material or act for performing the function in combination with other claimed elements as specifically claimed. The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. Aspects of the disclosure were chosen and described in order to best explain the principles of the invention and the practical application, and to enable others of ordinary skill in the art to understand the invention for various embodiments with various modifications as are suited to the particular use contemplated.

Having described the subject matter of the present disclosure in detail and by reference to specific embodiments, it is noted that the various details disclosed in the present disclosure should not be taken to imply that these details relate to elements that are essential components of the various described embodiments, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure may be identified as preferred or particularly advantageous, it is contemplated that the present disclosure is not necessarily limited to these aspects.

It will be apparent to those skilled in the art that various modifications and variations can be made to the described embodiments without departing from the spirit and scope of the claimed subject matter. Thus it is intended that the specification cover the modifications and variations of the various described embodiments provided such modification and variations come within the scope of the appended claims and their equivalents.

1. An internally-actuated fluid control valve comprising:
a valve assembly comprising an inlet bell, a capsule, a center frame, an outlet bell and a nacelle that together define an internal cavity with an annular fluid path extending therethrough;
an actuator assembly disposed entirely within the internal cavity and secured to the center frame, the actuator assembly comprising:
a source of motive power; and
a lead screw assembly responsive to the source of motive power to translate the capsule relative to the center frame along a portion of the annular fluid path that is fluidly upstream of the center frame.

2. The internally-actuated fluid control valve of claim 1, wherein a portion of the center frame that is disposed within the annular fluid path defines a plurality of vanes arranged as a guide vane array.

3. The internally-actuated fluid control valve of claim 2, wherein the plurality of vanes define a fluid dynamic fairing.

4. The internally-actuated fluid control valve of claim 3, wherein the fluid dynamic fairing is rigidly affixed to the center frame.

5. (canceled)

6. (canceled)

7. (canceled)

8. (canceled)

9. (canceled)

10. (canceled)

11. The internally-actuated fluid control valve of claim 1, wherein the center frame defines an axially forward-extending portion that contains the lead screw assembly therein.

12. The internally-actuated fluid control valve of claim 11, wherein the capsule and the axially forward-extending portion of the center frame define an axially-nested cooperation between them.

13. The internally-actuated fluid control valve of claim 12, wherein the axially-nested cooperation between the capsule and the axially forward-extending portion of the center frame define a radially outward-facing wall of the axially forward-extending portion of the center frame forms a substantially fluid-tight fit with a radially inward-facing wall of the capsule over at least a portion of a capsule axial travel path.

14. The internally-actuated fluid control valve of claim 13, further comprising at least one seal assembly disposed between the outward-facing wall of the axially forward-extending portion of the center frame and the radially inward-facing wall of the capsule over at least a portion of the capsule axial travel path.

15. The internally-actuated fluid control valve of claim 14, further comprising conduit that extends through the center frame and the nacelle to deliver a secondary fluid onto the at last one seal assembly.

16. The internally-actuated fluid control valve of claim 1, wherein the outlet bell defines a diverging flowpath fluidly downstream of the annular fluid path.

17. The internally-actuated fluid control valve of claim 16, further comprising an adjustable choke point that is formed fluidly adjacent the nacelle to cooperate with the diverging flowpath to define a converging-diverging exit nozzle.

18. The internally-actuated fluid control valve of claim 1, further comprising peripheral ejectors placed in the upstream portion and configured to allow one or more of a heating or cooling fluid air to be induced into the internally-actuated fluid control valve.

19. The internally-actuated fluid control valve of claim 1, wherein an external dimension thereof extends into a valve ambient environment substantially no more than that defined by piping to which the internally-actuated fluid control valve is fluidly coupled.

20. The internally-actuated fluid control valve of claim 1, further comprising conduit that extends through the center frame and the nacelle to deliver a secondary fluid into the annular fluid path adjacent the valve distal end.

21. The internally-actuated fluid control valve of claim 1, further comprising a thrust bearing configured to isolate at least one of a shaft coupling and an electric motor from at least one of a static and a dynamic load that is imparted to the capsule by an incoming fluid.

22. The internally-actuated fluid control valve of claim 1, wherein a structural enclosure that is defined by at least one of the inlet bell, center frame and outlet bell is constructed as a split case.

23. A method of controlling a fluid in a fluid handling system, the method comprising:
configuring a valve assembly to have an actuator assembly disposed entirely within a fluid flow and secured to at least a portion of the valve assembly, the actuator assembly comprising:
a source of motive power; and
a lead screw assembly responsive to the source of motive power to translate a portion of the actuator assembly relative to the valve assembly along a fluidly upstream portion of a fluid path that is defined in an internal cavity of the valve assembly; and
upon introduction of the fluid into the valve assembly, operating the actuator assembly to adjust the fluid flow through the valve assembly.

24. The method of claim 23, wherein the valve assembly comprises an inlet bell, a capsule, a center frame, an outlet bell and a nacelle that together define an internal cavity with an annular fluid path extending therethrough.

25. The method of claim 23, wherein operating the actuator assembly is performed by a computer-actuated controller.

26. The method of claim 23, wherein the fluid handling system comprises a first pipe fluidly coupled to an inlet portion of the valve assembly and a second pipe fluidly coupled to an outlet portion of the valve assembly.
